(19) United States
(12) Patent Application Publication
(10) Pub. No.: US 2012/0040043 A1
(43) Pub. Date: Feb. 16, 2012

(54) Modular Manifold System

(75) Inventors: Manon Danielle Belzile, Fairfield, VT (US); Timothy Peder Loucks, Shelburne, VT (US); Daniel Hontheim, Bettingen (DE); Gilles Lacome, Avril (FR)

(73) Assignee: HUSKY INJECTION MOLDING SYSTEMS LTD., Bolton (CA)

(21) Appl. No.: 13/265,862

(22) PCT Filed: Jul. 2, 2010
(86) PCT No.: PCT/US10/40873

§ 371 Date: Oct. 22, 2011

Related U.S. Application Data
(60) Provisional application No. 61/226,309, filed on Jul. 17, 2009.

(51) Int. Cl. B29C 45/72; B29C 45/80

(52) U.S. Cl. 425/547; 425/542; 264/39

(57) ABSTRACT

A modular manifold system 10 for an injection molding system having a distributor 18 for receiving molten material from a source, at least one melt tube 26 in fluid communication with the distributor 18 and at least one drop block 44, at least one nozzle assembly 48 in fluid communication with the at least one drop block 44, wherein the at least one melt tube 26 is not directly heated by a heater and may include a sleeve.

### TECHNICAL FIELD OF THE INVENTION

The present invention relates generally to the injection molding field and more specifically to modular manifold systems.

### BACKGROUND OF THE INVENTION

Traditional hot runner systems include among other things a manifold housed between a manifold plate and a backing plate. A sprue bushing is mounted to the manifold and is the interface between the machine nozzle and the manifold. The sprue bushing receives molten material from the machine nozzle and transfers it to the manifold. Nozzle assemblies are coupled to the opposite side of the manifold from where the sprue bushing is mounted. After the molten material is transferred from the sprue bushing to the manifold, it is then transferred to the nozzle assemblies and then to the mold cavities for producing parts.

The manufacturing of manifolds is costly and time consuming. For one piece manifolds, the manufacturing starts from a block of material, such as steel. The block of material is then machined down to its final configuration. Melt passages are machined into the manifolds by drilling and heater grooves are milled on at least one outer surface of the manifold. Heater elements are then installed in the heater grooves. Plugging of melt passages is also required. For two piece manifolds, grooves which form part of the melt passages are milled into the complementary halves. Thereafter, the halves are welded or bonded together such that the grooves define melt passages. Heater grooves are milled on at least one outer surface of the manifold. Heater elements are then installed in the heater grooves.

Once machined as described above, the completed manifold is only useable in its final configuration and is not reconfigurable. The problems with these traditional manifolds are that they are labor intensive to machine, expensive, not reconfigurable, have manufacturing long lead times, and require a significant amount of material such as steel.

Modular manifold systems have been introduced that overcome some of the disadvantages and problems associated with traditional manifold systems. However, even modular manifold systems are not without disadvantages and problems. For example, the positioning of drops is critical for efficiency. Unfortunately, modular manifold systems are not easily aligned because there are many connection points with the potential for variation in alignment.

The following is directed to overcoming one or more of the disadvantages or problems set forth above.

### SUMMARY OF THE INVENTION

The invention is set forth and characterized in the main claim(s), while the dependent claims describe other characteristics of the invention.

In one aspect of the present invention there is a modular manifold system 10 for an injection molding system having a distributor for receiving molten material from a source, at least one melt tube in fluid communication with the distributor and at least one drop block, at least one nozzle assembly in fluid communication with the drop block, wherein the at least one melt tube is not directly heated by a heater.

In another aspect of the invention, there is a modular manifold system for an injection molding system having a distributor for receiving molten material from a source, at least one melt tube in fluid communication with the distributor and at least one nozzle assembly, and an insulator configured to the melt tube.

In yet another aspect of the invention, there is a modular manifold system for an injection molding system having a distributor for receiving molten material from a source, at least one drop block in fluid communication with the distributor and at least one nozzle assembly in fluid communication with the drop block.

In still another aspect of the invention, there is a method for aligning a modular manifold system prior to assembly in a mold including the steps of placing the modular manifold system partially assembled between a plurality of plates, applying a compressive force to the modular manifold system via the plurality of plates, and securing the modular manifold system as it is positioned under the compressive force.

In yet still another aspect of the invention, there is a method for aligning a modular manifold system prior to assembly between a manifold plate and a backing plate including the steps of placing a center insulator into a centering bore in a bottom plate, placing a flange retainer onto a second end of a melt tube, threading the second end of the melt tube to a drop block, partially tightening screws of the flange retainer, assembling a backup pad on the drop blocks, placing the modular manifold system onto the bottom plate, centering the modular manifold system on the center insulator, placing the top plate on the backup pad of the modular manifold system, and tightening screws to compress the modular manifold system, and fully tightening the screws of the flange retainers.

These and other aspects and features of non-limiting embodiments of the present invention will now become apparent to those skilled in the art upon review of the following description of specific non-limiting embodiments of the invention in conjunction with the accompanying drawings.

### BRIEF DESCRIPTION OF THE DRAWINGS

The invention and its embodiments will be more fully appreciated by reference to the following detailed description of illustrative (non-limiting) embodiments in accordance with the present invention when taken in conjunction with the accompanying drawings, in which:

FIG. 1 is a cross-sectional view of a modular manifold system according to a first non-limiting embodiment.

FIG. 2 is an isometric view of the modular manifold system according to another non-limiting embodiment.

FIG. 3 is a cross-sectional view of a portion of the modular manifold system according to still another non-limiting embodiment.

FIG. 4 is a cross-sectional view of a portion of the modular manifold system according to yet another non-limiting embodiment.

FIG. 5 is an isometric view of a drop block and insert of the modular manifold system shown in FIG. 2.

FIG. 6 is an exploded view of an alignment device for the modular manifold system.

FIG. 7 is an exploded view of the alignment device utilizing wedges with the modular manifold system.

FIGS. 8A & 8B are cross-sectional views of a portion of the modular manifold system having an adapter incorporated therein.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

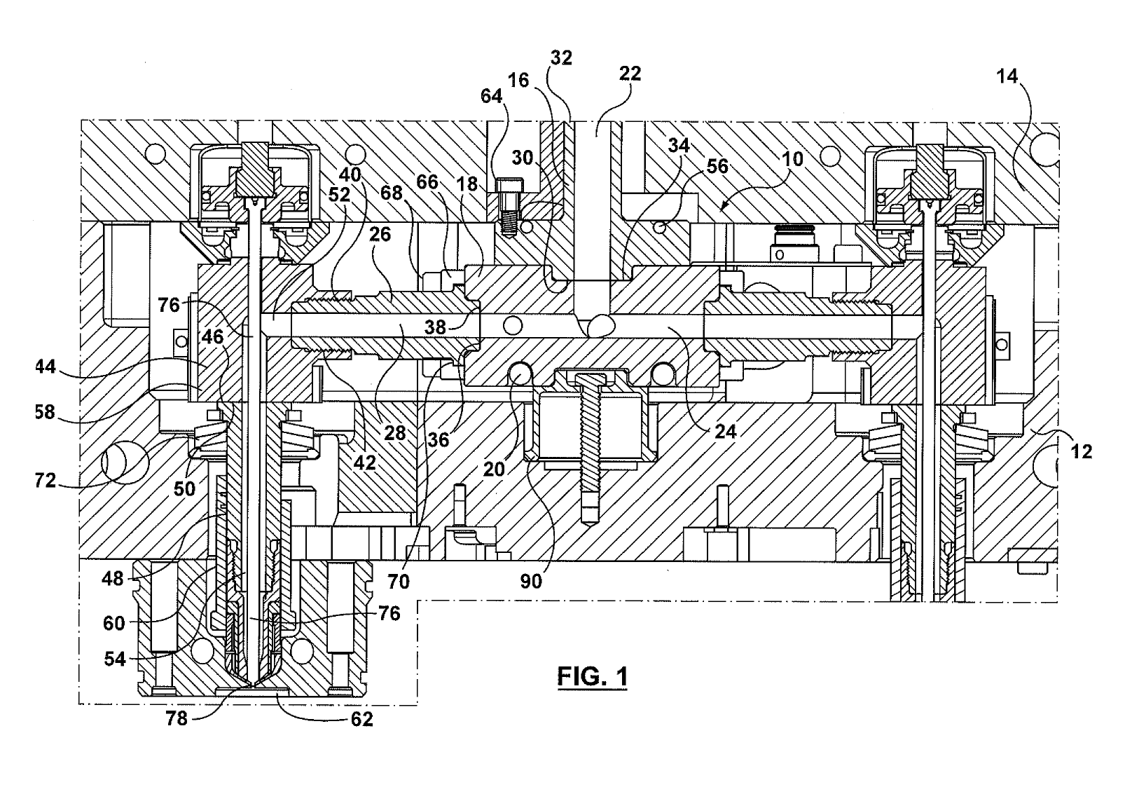

Referring now to the drawings and initially to FIG. 1 which is a non-limiting and example embodiment, a modular manifold system 10 is shown housed between a manifold plate 12 and a backing plate 14. The modular manifold system 10 includes a sprue bushing 16 having an inlet end 32 and a flow passage 22 in fluid communication with a machine nozzle (not shown) of an injection molding machine. The sprue bushing 16 is heated with a heater 56. In an alternative embodiment, the sprue bushing 16 is not heated by the heater 56. An exit end 30 of the sprue bushing 16 is operatively attached to an inlet end 34 of a distributor 18. In one embodiment, the sprue bushing 16 is operatively mounted to the distributor 18 via sprue bushing screws 64. In an alternative embodiment, the sprue bushing 16 and distributor 18 are integral. The flow passage 22 of the sprue bushing 16 is in fluid communication with flow passages 24 of the distributor 18. The distributor 18 is heated by one or more heater 20 and is located with a center insulator 90. Exit ends 36 of the distributor 18 are also operatively attached to first ends 38 of the melt tubes 26. In one embodiment, the first ends 38 of the melt tubes 26 are seated against the distributor 18 and secured thereto with flange retainers 66 and screws 68. Shoulders 70 of the melt tubes 26 are trapped or secured between the flange retainers 66 and the distributor 18 via the screws 68. The flow passages 24 of the distributor 18 are in fluid communication with flow passages 28 of the melt tubes 26. The melt tubes 26 may or may not be heated by a heater (not shown). The melt tubes 26 without heaters may or may not contain insulation. The insulation may be any insulative material such as a silica blanket for example. In the embodiment not utilizing a heater or insulation, the material used for the melt tubes 26 is sufficiently conductive to maintain the molten material in its molten state along the length of the flow passages 28 of the melt tubes 26, thereby eliminating the need for a heater, thermally conductive sleeve, or insulation. In another embodiment, the melt tubes 26 contain both a heater and insulator. The melt tubes 26 may be made from steel or a copper based alloy for example. It is analytically possible to determine at which lengths of the melt tubes 26 not having heaters require insulative material around the circumference of the melt tubes 26 to maintain the molten material in a molten state. It is also analytically possible to determine at which lengths of the melt tubes 25 heaters would be required in lieu of the insulative material to maintain the molten material in a molten state along the length of the flow passages 28 of the melt tubes 26. Second ends 40 of the melt tubes 26 are operatively attached to inlet ends 42 of drop blocks 44. In one embodiment, the second ends 40 of the melt tubes 26 are threaded to the inlet ends 42 of the drop blocks 44. The flow passages 28 of the melt tubes 26 are in fluid communication with flow passages 52 of the drop blocks 44. Outlet ends 46 of the drop blocks 44 are in sliding engagement with first ends 50 of nozzle assemblies 48. In one example, the nozzle assemblies 48 are held in sliding engagement with the drop block 44 via a spring pack 72. The spring pack 72 provides sufficient seal-off force to preclude leakage between the nozzle assemblies 48 and the drop blocks 44. In other embodiments, the nozzle assemblies 48 may be fixed to the drop blocks 44 via screws or other securing devices (not shown). The drop blocks 44 are heated by heaters 58. The heaters 58 may be film heaters, plasma spray heaters, coil heaters, cartridge heaters, or other known heating devices. The flow passages 52 of the drop blocks 44 are in fluid communication with flow passages 54 of the nozzle assemblies 48. The nozzle assemblies 48 are heated by heaters 60. The flow passages 54 of the nozzle assemblies 48 are in fluid communication with a mold cavity 62.

The flow of molten material to the mold cavities 62 is controlled by valve stems 76. To preclude or cease the flow of molten material to the mold cavities 62, tips 78 of the valve stems 76 plug or block the gate areas. To allow the flow of molten material to the mold cavities 62, the valve stems 76 are retracted such that the tips 78 of the valve stems 76 do not plug or block the gate areas.

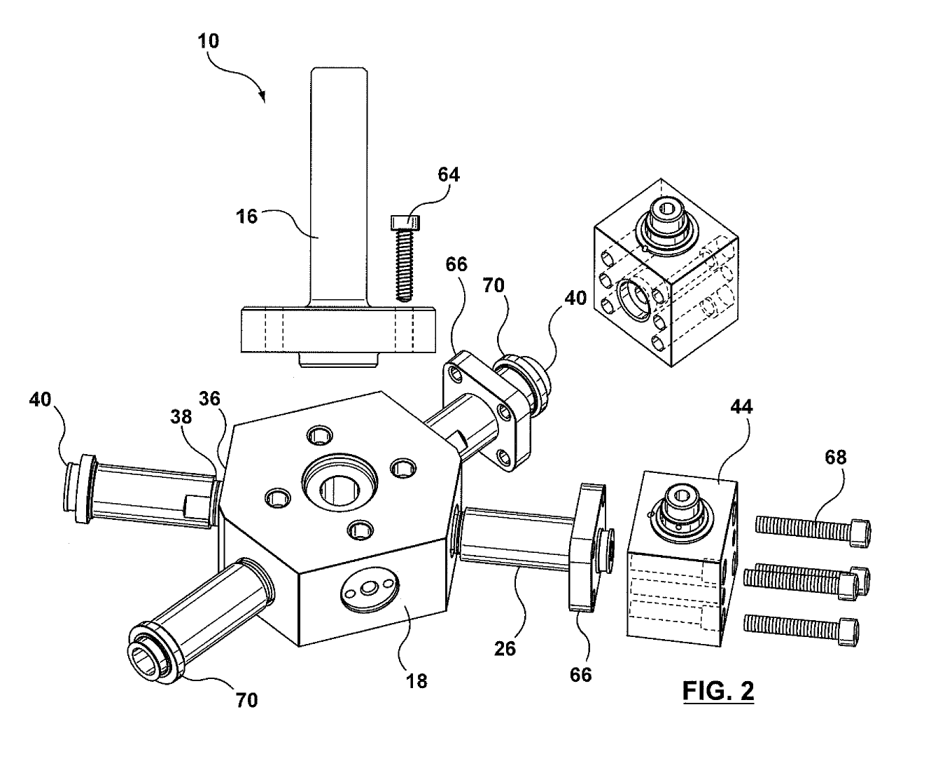

Turning now to another embodiment of the modular manifold system 10 as shown in FIG. 2, the sprue bushing 16 is operatively mounted to the distributor 18 via sprue bushing screws 64. The first ends 38 of the melt tubes 26 are threaded to the exit ends 36 of the distributor 18. The second ends 40 of the melt tubes 26 are seated against the drop blocks 44 and secured thereto with the flange retainers 66 and screws 68. The shoulders 70 of the melt tubes 26 are trapped or secured between the flange retainers 66 and the drop blocks 44 via the screws 68. The nozzle assemblies 48 are operatively attached to the drop blocks 44. In this embodiment, the flange retainers 66 are assembled to the drop blocks 44 and the melt tubes 26 are threaded to the distributor 18 whereas the embodiment shown in FIG. 1 has the flange retainers 66 assembled to the distributor 18 and the melt tubes 26 threaded to the drop blocks 44.

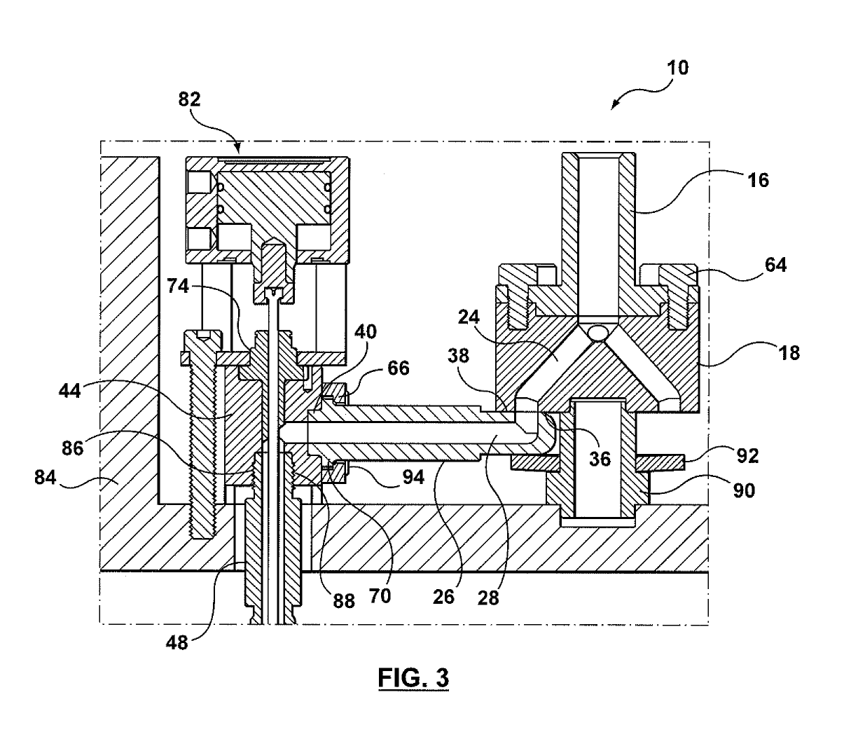

Turning now to still another embodiment of the modular manifold system 10 as shown in FIG. 3, in this embodiment the locations of the drops, including but not limited to actuators 82, the drop blocks 44, stem guides 74 (if used), and nozzle assemblies 48 may be fixed. In one example, the drops are removably secured to a manifold plate 84. This fixed drop embodiment allows for the utilization of screw-in type nozzle assemblies 48. For example, upper ends 86 of the nozzle assemblies 48 are threaded to and received by complementary threaded ends 88 of the drop blocks 44. This facilitates, among other things, removal and replacement of the nozzle assemblies 48 in the field without disassembling the manifold plate 84 and the backing plate (not shown). The sprue bushing 16 is operatively mounted to the distributor 18 via sprue bushing screws 64. The first ends 38 of the melt tubes 26 are slidably engaged to the exit ends 36 of the distributor 18. In the cold condition, the flow passages 24 of the distributor 18 are slightly offset from the flow passages 28 of the melt tubes 26. After heat up and in the operating condition as shown in FIG. 3, the flow passages 24 of the distributor 18 align with the flow passages 28 of the melt tubes 26. The first ends 38 of the melt tubes 26 are held in sliding engagement to the exit ends 36 of the distributor 18 by the center insulator 90 and spring 92. In an alternative embodiment, a ceramic disc (not shown) may be used between the spring 92 and the melt tubes 26. The second ends 40 of the melt tubes 26 are seated against the drop blocks 44 and secured thereto with the flange retainers 66 and retaining rings 94. The shoulders 70 of the melt tubes 26 are trapped or secured between the flange retainers 66 and the drop blocks 44 via the retaining ring 94.

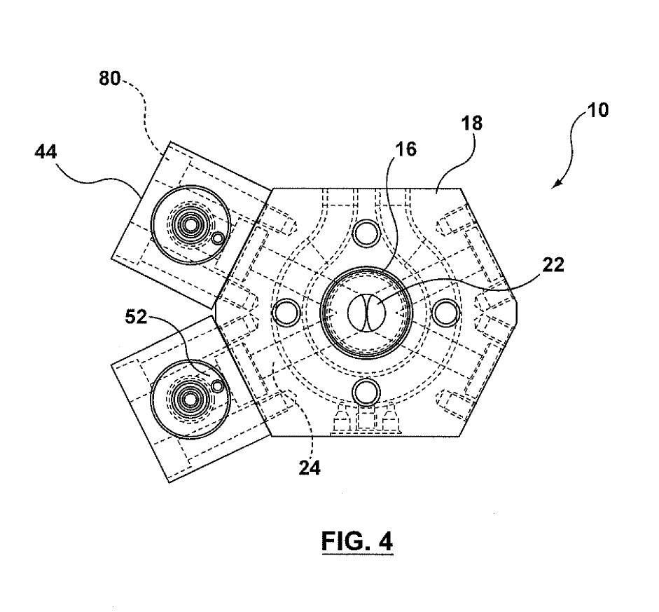

In an alternative embodiment shown in FIG. 4, the modular manifold system 10 does not utilize the melt tubes 26 previously described. The drop blocks 44 are operatively attached to the distributor 18 without the melt tubes 26 located therebetween. In one embodiment, block screws 80 are used to attach the drop blocks 44 to the distributor 18. This embodiment accommodates small pitch designs.

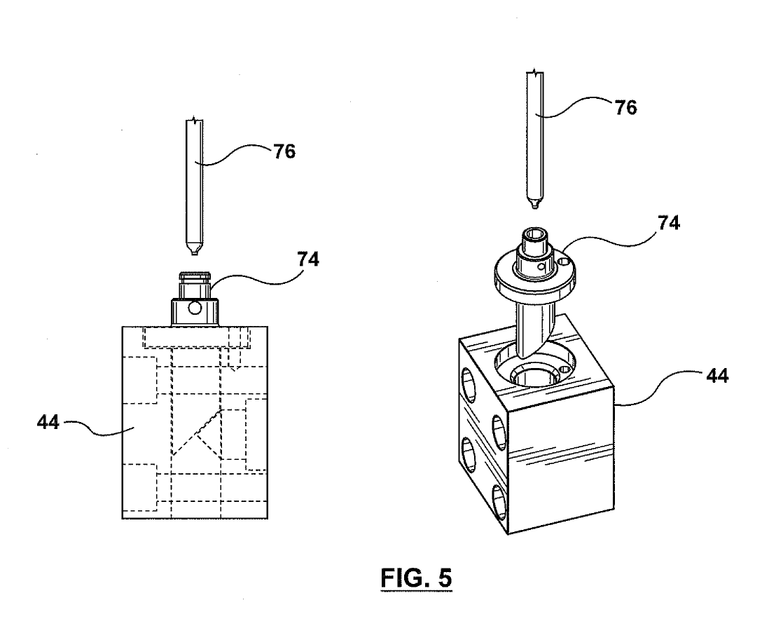

Referring now to FIG. 5, the drop block 44 is shown having a stem guide 74. The stem guide 74 may be implemented in any of the embodiments described herein. The stem guide 74 guides the valve stem 76 and precludes flow between it and the valve stem 76. In one embodiment, the stem guide 74 is made from a material that is different from the material of the drop block 44. For example, to reduce wear, the stem guide 74 may be made from a wear resistant material such as hardened tool steel or ceramic for example. In another example, to reduce heat transfer from the nozzle assemblies 48 to the valve stem 76, the stem guide 74 may be made from a low thermally conductive material such as ceramics and titanium for example. In yet another example, to reduce galling, the stem guide 74 may be made from a material having a certain hardness criteria such as hardened tool steel or ceramic for example. In still another example, thermal transfer between stem guide 74 and the drop block 44 is reduced by limiting the contact surfaces between the two parts. In another embodiment, the drop block 44 does not have the stem guide 74.

During operation of the embodiments shown in FIGS. 1-3, the machine nozzle injects molten material into the modular manifold system 10 through the flow passage 22 of the sprue bushing 16 which leads to the flow passages 24 of the distributor 18. The molten material is then transferred to the flow passages 28 of the melt tubes 26 and onto the flow passages 52 of the drop blocks 44. The molten material is then transferred to the flow passages 54 of the nozzle assemblies 48 and ultimately into the mold cavities 62 to produce parts after cooling and solidification of the molten material.

During operation of the embodiment shown in FIG. 4, the machine nozzle injects molten material into the modular manifold system 10 through the flow passage 22 of the sprue bushing 16 which leads to the flow passages 24 of the distributor 18. Then, the molten material is transferred to the flow passages 52 of the drop blocks 44 and then onto the flow passages 54 of the nozzle assemblies 48 and ultimately into the mold cavities 62 to produce parts after cooling and solidification of the molten material.

In the embodiments disclosed herein, the distributor 18 may be manufactured from common blanks. In other words, the blanks are not unique to each design and may be standard for all designs. For example, the same blank may be used for a two-drop or four-drop system. Further, the same blank may be used for a variety of pitch dimensions. The melt tubes 26 may be inventoried at one length and cut to length after an order is received. Various inventories for the melt tubes 26 may be kept because the melt flow channel sizes of the melt tubes 26 as measured from the outside diameter vary (for example, 0.250 of an inch, 0.350 of an inch, 0.500 of an inch, etc.). After an order is received for a certain diameter, the melt tubes 26 having that diameter may be cut to length and at least one of the ends threaded depending on the application. The drop blocks 44 may be mass produced and inventoried to the various melt flow channel sizes of the drop blocks 44. If stem guides 74 are used with the drop blocks 44, the stem guides 74 may also be mass produced and inventoried to the various melt flow channel sizes of the stem guides 74. With regard to the drop blocks 44, additional inventories may be kept containing valve gate style nozzle assemblies 48 and hot tip style nozzle assemblies.

As mentioned above, the melt tubes 26 may contain heaters. In one embodiment, heaters are applied directly to the components, including the melt tubes 26, of the modular manifold system 10 with a plasma spray process. Prior to plasma spraying the components, the outside surfaces of the components are sandblasted. A dielectric layer is deposited onto the outside surfaces of the components with plasma spray or more specifically atmospheric plasma spray (APS). One type of dielectric material is aluminum oxide but other materials having similar dielectric properties could be used. A resistive layer is deposited over the dielectric layer with APS. The resistive layer is made primarily from nichrome (80% nickel and 29% chromium) along with other materials, for example. Thereafter, a laser is used to etch away certain portions of the resistive layer. The remaining resistive layer serves as the heating circuit. Ends of the heating circuit or connector points are masked with for example laser cut foil. A dielectric layer is deposited onto the areas that have been removed by the laser and the remaining resistive layer with APS. The masking is removed from the ends of the heating circuit or the connector points. Power leads are connected to the ends of the heating circuit or the connector points. Thereafter, a moisture barrier layer is deposited over the last applied dielectric layer and ends of the heating circuit or the connector points. The moisture barrier is made primarily from zirconia, zirconium dioxide, or aluminum oxide, all of which may be combined with other materials, for example.

The previously described modular manifold systems 10 may be reconfigurable and provides for reusability of components for different applications. In one reconfigurable embodiment, the lengths of the melt tubes 26 are modified to accommodate different pitches or applications. The sprue bushing 16, distributor 18, drop blocks 44, and nozzle assemblies 48 are reusable whereas the melt tubes 26 are replaced from one pitch or application to another pitch or application. Typically, the melt tubes 26 will be swapped out with melt tubes 26 having different lengths or cut to smaller lengths to fit the new application. In another embodiment, the modular manifold system 10 may have melt tubes 26 with different lengths and/or diameters. In another embodiment, the configuration of the distributor 18 may be manufactured to accommodate various pitch applications.

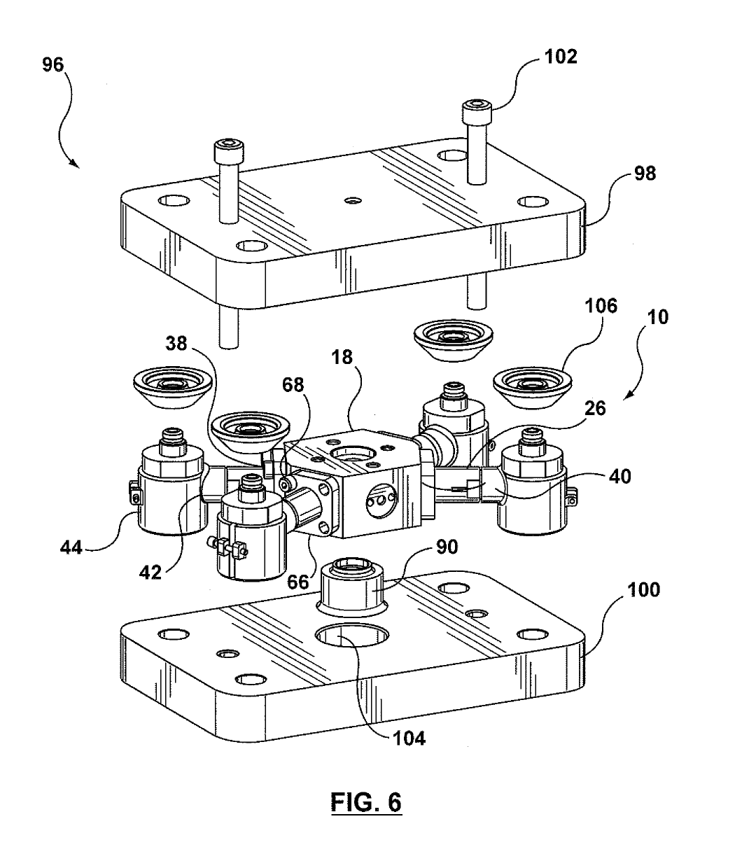

The distributor 18, melt tubes 26, and drop blocks 44 previously described with regard to the modular manifold systems 10 may be aligned prior to assembly to the nozzle assemblies 48 and plates (not shown). Referring now to FIG. 6, an alignment device 96 includes a top plate 98, a bottom plate 100, and screws 102. The top plate 98 may be ground flat. The bottom plate 100 may be ground flat and contains a centering bore 104 for receiving the center insulator 90 of the modular manifold system 10. The alignment device 96 may be used to pre-align a wide range of pitch spacing applications including the various embodiments described herein. In the following alignment process, the embodiment of the modular manifold system 10 described in FIG. 1 will be referenced. The alignment process includes the following steps: 1) the center insulator 90 is placed into the centering bore 104 of the bottom plate 100; 2) the flange retainers 66 are slipped onto the second ends 40 of the melt tubes 26 and slid down to the shoulders 70 proximate the first ends 38 of the melt tubes 26; 3) the second ends 40 of the melt tubes 26 are threaded onto the inlet ends 42 of drop blocks 44; 4) the first ends 38 of the melt tubes 26 are seated against the distributor 18 and the screws 68 are partially threaded thereby trapping the shoulders 70 of the melt tubes 26 between the flange retainers 66 and the distributor 18; 5) backup pads 106 are assembled to the drop blocks 44; 6) the partially assembled modular manifold system 10 is then placed onto the bottom plate 100 and centered on the center insulator 90; 7) the top plate 98 is placed onto the top of the partially assembled modular manifold system 10; 8) the screws 102 are tightened down to compress the partially assembled modular manifold system 10 such that a 0.030 mm shim cannot pass under the drop block 44; and 9) the screws 68 of the flange retainers 66 are fully tourqued to a predetermined load to ensure sealing. This process and the alignment device 96 provide planar alignment of the modular manifold system 10 and orientate the drop blocks 44 with respect to a mold (not shown).

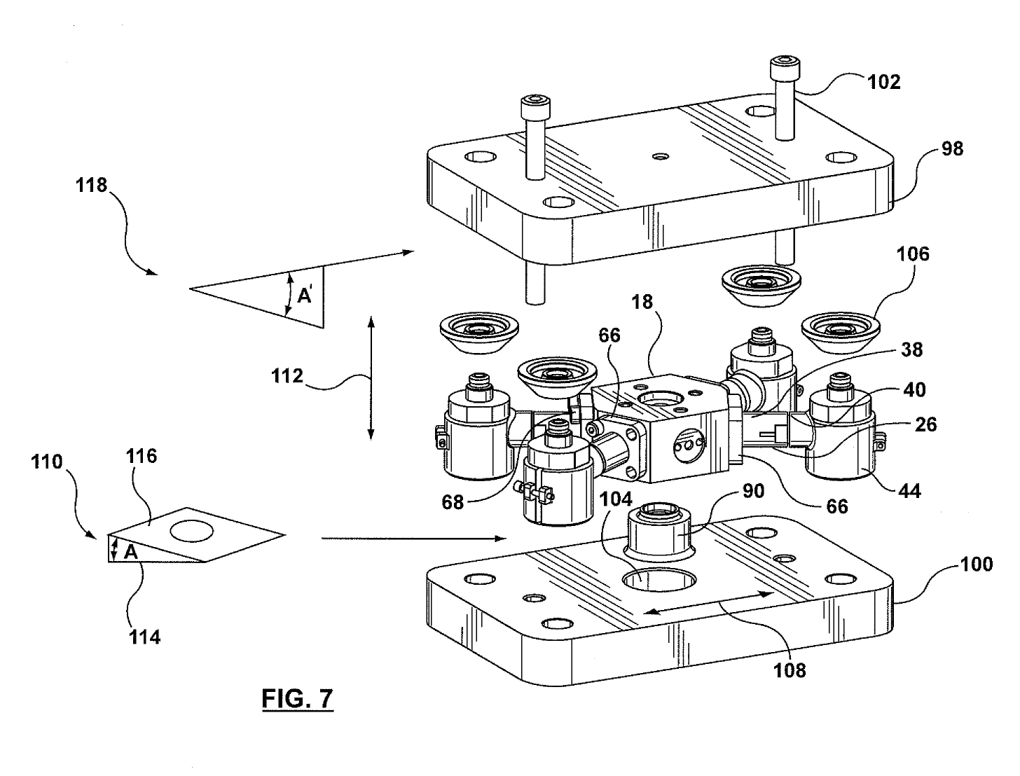

Referring now to FIG. 7, in certain applications, it may be desirable to angle the drops with respect to a vertical axis 112 of the modular manifold system 10. To vary the angle of the drops, the drop blocks 44 are angled with respect to the vertical axis 112. Wedges 110 may be used between the drop blocks 44 and the bottom plate 100 to place the drop blocks 44 at the desired angle. The wedges 110 have a bottom surface 114 which is substantially flat and parallel with a horizontal axis 108 of the bottom plate 100. The wedges 110 have a top surface 116 which is at an angle A with respect to the bottom surface 114. When the wedges 110 are placed between the drop blocks 44 and the bottom plate 100, the drop blocks 44 are placed onto the wedges 110 and thus positioned at the angle A, which is consistent with the desired angle of the drops. When the wedges 110 are used with the modular manifold systems 10, the alignment process includes the following steps: 1) the center insulator 90 is placed into the centering bore 104 of the bottom plate 100; 2) the flange retainers 66 are slipped onto the second ends 40 of the melt tubes 26 and slid down to the shoulders 70 proximate the first ends 38 of the melt tubes 26; 3) the second ends 40 of the melt tubes 26 are threaded onto the inlet ends 42 of drop blocks 44; 4) the wedges 110 are placed where the drop blocks 44 would come in contact with the bottom plate 100; 5) the first ends 38 of the melt tubes 26 are seated against the distributor 18 and the screws 68 are partially threaded thereby trapping the shoulders 70 of the melt tubes 26 between the flange retainers 66 and the distributor 18; 6) the backup pads 106 are assembled to the drop blocks 44; 7) the partially assembled modular manifold system 10 is then centered on the center insulator 90 and placed on the bottom plate 100 such that the drop blocks 44 are seated on the wedges 110; 8) complementary wedges 118 having a complementary angle A′ to the angle A of the wedges 110 are secured to the top plate 98 where the backup pads 106 would come in contact with the top plate 98; 9) the top plate 98 is placed onto the top of the partially assembled modular manifold system 10; 8) the screws 102 are tightened down to compress the partially assembled modular manifold system 10 such that a 0.030 mm shim cannot pass under the drop block 44; and 9) the screws 68 of the flange retainers 66 are fully tourqued to a predetermined load to ensure sealing. This process and the alignment device 96 provide planar alignment of the distributor 18 and angular alignment of the drop blocks 44 with respect to a mold (not shown).

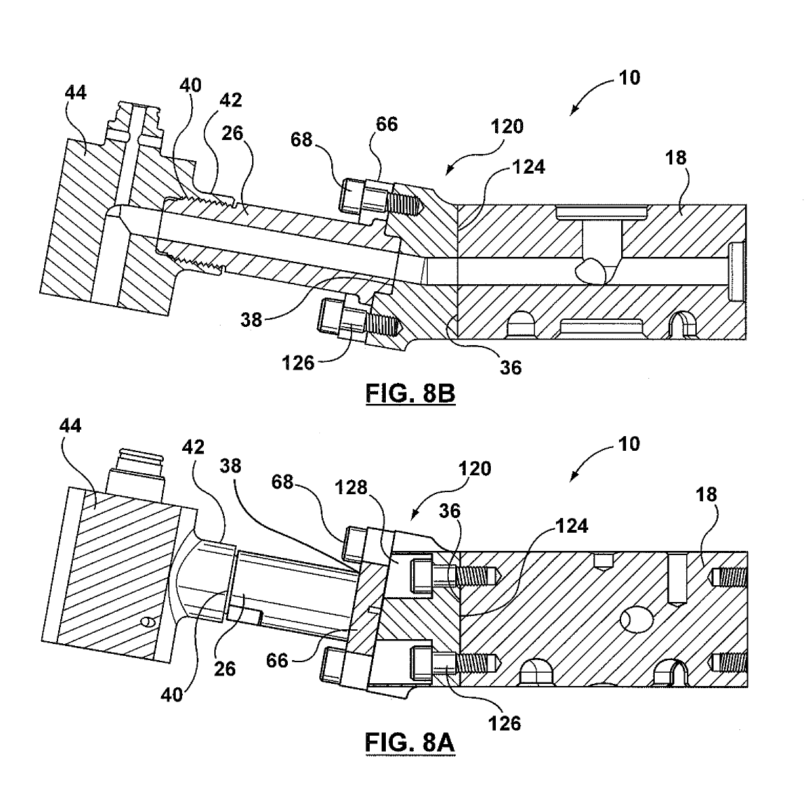

Referring now to FIGS. 8A & 8B, adapters 120 may be used with the melt tubes 26. The adapters 120 provide for mounting the melt tubes 26 and the drop blocks 44 to position the melt tubes 26 at an upward or downward angle. The adapters 120 have surfaces 124 for mounting substantially flush and parallel with the exit ends 36 of the distributor 18. The adapters 120 have bores 128 so that adapter screws 126 may be used to secure the adapters 120 to the distributor 18. Referring now in combination to FIGS. 6, 8A, and 8B, the process of assembling the modular manifold system 10 having the adapters 120 includes the following steps: 1) the flange retainers 66 are slipped onto the second ends 40 of the melt tubes 26 and slid down to the shoulders 70 proximate the first ends 38 of the melt tubes 26; 2) the second ends 40 of the melt tubes 26 are threaded onto the inlet ends 42 of drop blocks 44; 3) the adapters 120 are attached to the distributor 18 with the adapter screws 126; 4) the first ends 38 of the melt tubes 26 are seated against the adapters 120 and the screws 68 are fully tourqued to a predetermined load to ensure sealing, thereby trapping the shoulders 70 of the melt tubes 26 between the flange retainers 66 and the adapters 120; and 5) the backup pads 106 are assembled to the drop blocks 44.

The modular manifold systems 10 described above referred to a valve gate system. In an alternative embodiment, the modular manifold system 10 may also be a hot tip system. In the hot type system embodiment, there is not actuation system (e.g, piston, cylinder, seals, etc.), valve stem, or valve stem hole in the drop block 44.

It is noted that the foregoing has outlined some of the more pertinent non-limiting embodiments. These embodiments may be used for many applications. Thus, although the description is made for particular arrangements and methods, the intent and concept of the embodiments are suitable and applicable to other arrangements and applications. It will be clear to those skilled in the art that modifications to the disclosed non-limiting embodiments can be effected. The described non-limiting embodiments ought to be construed to be merely illustrative of some of the more prominent features and applications. Other beneficial results can be realized by applying the disclosed embodiments in a different manner or modifying them in ways known to those familiar with the art. The mixing and matching of features, elements, and/or functions between various non-limiting embodiments are expressly contemplated herein, unless described otherwise, above.

What is claimed is:

1. A modular manifold system 10 for an injection molding system, comprising a distributor 18 for receiving molten material from a source, at least one melt tube 26 in fluid communication with the distributor 18 and at least one drop block 44, at least one nozzle assembly 48 in fluid communication with the at least one drop block 44, wherein the at least one melt tube 26 is not directly heated by a heater.

2. The modular manifold system 10 according to claim 1, further comprising at least one wedge 110 configured to the at least one drop block 44.

3. The modular manifold system 10 according to claim 1, further comprising at least one stem guide 74 configured to the at least one drop block 44.

4. The modular manifold system 10 according to claim 1, further comprising at least one flange retainer 66 for securing the at least one melt tube 26 to either the distributor 18 or the at least one drop block 44.

5. The modular manifold system 10 according to claim 1, further comprising at least one spring pack 72 for positioning the at least one nozzle assembly 48 in slidable and sealable engagement with the at least one drop block 44.

6. The modular manifold system 10 according to claim 1, wherein the at least one nozzle assembly 48 is fixed to the at least one drop block 44.

7. The modular manifold system 10 according to claim 1, where in the at least one melt tube 26 has a first end 38 and a second end 40, the first end 38 or the second end 40 of the at least one melt tube 26 in slidable and sealable engagement with either an exit end 36 of the distributor 18 or an inlet end 42 of the at least one drop block 44, respectively.

8. The modular manifold system 10 according to claim 7, further including a spring 92 for configuring the first end 38 or the second end 40 of the at least one melt tube 26 in slidable and sealable engagement with either the exit end 36 of the distributor 18 or the inlet end 42 of the at least one drop block 44, respectively.

9. The modular manifold system 10 according to claim 1, further comprising at least one adapter 120 configured to the at least one melt tube 26.

10. A modular manifold system 10 for an injection molding system, comprising a distributor 18 for receiving molten material from a source, at least one melt tube 26 in fluid communication with the distributor 18 and at least one nozzle assembly 48, and an insulator configured to the at least one melt tube 26.

11. The modular manifold system 10 according to claim 10, further comprising at least one wedge 110 configured to the at least one drop block 44.

12. The modular manifold system 10 according to claim 10, further comprising at least one stem guide 74 configured to the at least one drop block 44.

13. The modular manifold system 10 according to claim 10, further comprising at least one flange retainer 66 for securing the at least one melt tube 26 to either the distributor 18 or the at least one drop block 44.

14. The modular manifold system 10 according to claim 10, further comprising at least one spring pack 72 for positioning the at least one nozzle assembly 48 in slidable and sealable engagement with the at least one drop block 44.

15. The modular manifold system 10 according to claim 10, wherein the at least one nozzle assembly 48 is fixed to the at least one drop block 44.

16. The modular manifold system 10 according to claim 10, where in the at least one melt tube 26 has a first end 38 and a second end 40, the first end 38 or the second end 40 of the at least one melt tube 26 in slidable and sealable engagement with either an exit end 36 of the distributor 18 or an inlet end 42 of the at least one drop block 44, respectively.

17. The modular manifold system 10 according to claim 16, further including a spring 92 for configuring the first end 38 or the second end 40 of the at least one melt tube 26 in slidable and sealable engagement with either the exit end 36 of the distributor 18 or the inlet end 42 of the at least one drop block 44, respectively.

18. The modular manifold system 10 according to claim 10, further comprising at least one adapter 120 configured to the at least one melt tube 26.

19. A modular manifold system 10 for an injection molding system, comprising a distributor 18 for receiving molten material from a source, at least one drop block 44 in fluid communication with the distributor 18 and at least one nozzle assembly 48 in fluid communication with the at least one drop block 44.

20. The modular manifold system 10 according to claim 19, further comprising at least one wedge 110 configured to the at least one drop block 44.

21. The modular manifold system 10 according to claim 19, further comprising at least one stem guide 74 configured to the at least one drop block 44.

22. The modular manifold system 10 according to claim 19, further comprising at least one spring pack 72 for positioning the at least one nozzle assembly 48 in slidable and sealable engagement with the at least one drop block 44.

23. The modular manifold system 10 according to claim 19, wherein the at least one nozzle assembly 48 is fixed to the at least one drop block 44.

24. A method for aligning a modular manifold system 10 prior to assembly in a mold, the method comprising the steps of:
placing the modular manifold system 10 partially assembled between a plurality of plates 98, 100;
applying a compressive force to the modular manifold system 10 via the plurality of plates 98, 100; and
securing the modular manifold system 10 as it is positioned under the compressive force.

25. A method for aligning a modular manifold system 10 prior to assembly between a manifold plate 12 and a backing plate 14, the method comprising the steps of:
placing a center insulator 90 into a centering bore 104 in a bottom plate 100;
placing a flange retainer 66 onto a second end 40 of a melt tube 26;
threading the second end 40 of the melt tube 26 to a drop block 44;
partially tightening screws 68 of the flange retainer 66;
assembling a backup pad 106 on the drop block 44;
placing the modular manifold system 10 onto the bottom plate 100;
centering the modular manifold system 10 on the center insulator 90;
placing a top plate 98 on the backup pad 106 of the modular manifold system 10; and
tightening screws 102 to compress the modular manifold system 10; and
fully tightening the screws 68 of the flange retainer 66.

26. A modular manifold system 10 for an injection molding system, comprising a distributor 18 for receiving molten material from a source, at least one melt tube 26 in fluid communication with the distributor 18 and at least one drop block 44, at least one nozzle assembly 48 in fluid communication with the at least one drop block 44, wherein the at least one melt tube 26 has a plasma spray heater.

27. A modular manifold system 10 for an injection molding system, comprising a distributor 18 for receiving molten material from a source, at least one melt tube 26 in fluid communication with the distributor 18 and at least one drop block 44, at least one nozzle assembly 48 in fluid communication with the at least one drop block 44, wherein the distributor 18 has a plasma spray heater.

28. A modular manifold system 10 for an injection molding system, comprising a distributor 18 for receiving molten material from a source, at least one melt tube 26 in fluid communication with the distributor 18 and at least one drop block 44, at least one nozzle assembly 48 in fluid communication with the at least one drop block 44, wherein the at least one drop block 44 has a plasma spray heater.

29. A modular manifold system 10 for an injection molding system, comprising a distributor 18 for receiving molten material from a source, at least one melt tube 26 in fluid communication with the distributor 18 and at least one drop block 44, at least one nozzle assembly 48 in fluid communication with the at least one drop block 44, wherein the at least one nozzle assembly 48 has a plasma spray heater.
